(19) United States
(12) Patent Application Publication
(10) Pub. No.: US 2016/0008204 A1
(43) Pub. Date: Jan. 14, 2016

(54) Inflatable Medical Compression Device

(71) Applicant: Jerry C Elliot, Oklahoma City, OK (US)

(72) Inventor: Jerry C Elliot, Oklahoma City, OK (US)

(21) Appl. No.: 14/329,264

(22) Filed: Jul. 11, 2014

(51) Int. Cl. A61H 1/00

(52) U.S. Cl. CPC A61H 1/008; A61H 2201/0103

(57) ABSTRACT

The disclosed invention aids the treatment of vascular problems with blood circulation in the body extremities by mechanically increasing or assisting the venous blood flow and prevents or minimizes shock through the application of controlled external pressure. In an alternate use, the device can also he used to compress a limb wound to reduce loss of blood in accidents and injuries during military operations. The invention comprises of two inflatable air bladders with a switchable filling valve to enable inflation of both bladders simultaneously or separately. The invention is inflated by either air or liquids for compression, fillable by mouth or hand pump, with the level of compression controllable by the user or installer. The invention is of reduced weight, allows as of manufacture and is of low cost. The invention is highly portable arid storable for battlefield or ambulance emergency care uses, flexible, easily and quickly installed.

### BACKGROUND OF THE INVENTION

The invention relates generally to compression device and inflammation care, treatment of trauma, bleeding and other medical conditions requiring or aided by a controlled general pressure applied to a limb for which control of bleeding or blood circulation is indicated. The invention is also generally useful for the prevention or minimization of deep vein thrombosis and varicose veins in elderly, wheelchair and bed-confined patients who are non-ambulatory.

The current method of treating vascular problems has been to slip the limb, typically the leg, into an elastic type stocking or rubberized trousers. These are typically expensive and difficult to use either by the individual user or outside of a hospital or clinical setting. Similarly, existing military or emergency care methods to control bleeding caused by traumatic injury have serious drawbacks to cost, efficiency, effectiveness, design & operation and particularly patient safety concerns. Military anti-shock trousers or Pneumatic Anti-Shock Garments, referred to herein respectively as MASTs or PASGs, are medical devices used to treat severe blood loss. They are also indicated for the stabilization of unstable pelvic fractures in the field prior to transport. They are opened and placed around the legs and pelvis of the patient. Each leg and the pelvic section may then be inflated, applying pressure to the lower half of the body The trousers can be used with sager traction splints and dressings already in place.

MASTs or similar devices are typically carried and used by emergency medical technicians and paramedics and are sometimes carried by fire department first responder trucks. In some states, first responders can apply and inflate them under direct medical supervision.

The exact way in which MAST helps is uncertain. The most common theory is that the pressure decreases blood flow to the legs (thus increasing availability of blood to the rest of the body) and actually squeezes blood out of the lower body. It may be that increased perfusion to the brain and other organs also have indirect benefits.

There is some controversy over use of MAST. One question is whether the increased peripheral vascular resistance may reduce cardiac output or rupture existing clots. Due to these questions and several human studies that have shown no advantage to patients with a high degree of blood loss above the pelvis, MAST trousers are being used much less often now than they were the 1980s and early 1990s. Another reason they have fallen into disuse is the tendency for emergency room nurses and physicians to cut the inflated trousers off, which can cause a catastrophic drop in blood pressure, as well as equipment destruction and an increased strain on budgets.

While the PASG and MASTs can be useful adjuncts in the treatment of hemorrhagic shock in certain circumstances, either device can worsen the problem in others.

One absolute contraindication for the PASG is the presence of pulmonary edema. For thi reason, the application of the PASG is usually restricted to qualified medical personnel, under the direction of a physician.

Numerous reasons exist for the need to control bleeding or blood circulation in the legs or arms, including, without limitation: trauma or excessive bleeding, venous stasis ulcers, impaired venous circulation, varicose veins.

There is a need for a device suitable to control bleeding or blood circulation in the limbs of individuals in need of health care treatment which can be used in an emergencies or for daily care. There is a further need for a device suitable to be used by health care support personnel, first responders or by individuals without the need for extensive or specialized training.

### SUMMARY OF THE INVENTION

Generally, the device comprises two separate, double walled, sealed and air tight bladders with an interconnecting T-Valve between the bladders to allow air flow into each bladder simultaneously. The T-Valve can be installed easily on the nipples formed on the bladders, or it can be hermetically sealed as a permanent installation on both bladders. Any external inflation source, including lung power, hand pump, motorized pump or otherwise, can be used. An additional valve in the T-valve allows the user to close inflation to one bladder or the other, if desired by the user. A flexible T-Valve flapper is bonded to one edge of the lower extremity of the nipple and allowed to move freely as a hinge to shut off the air intake when a degree of back-pressure is reached. This closes the flexible valve flap and keeps it in a closed position.

Additional air may be forced into the bladders through the nipple with enough air pressure to overcome the back pressure pushing against the opposite pressure on the flapper valve. Significantly, the invention is of light weight construction, is easily transportable and storable.

In additional the invention includes design features of liquid fill port for treatment of varicose veins, anti-edema, abdominal surgery, hip replacement surgery, knee replacement surgery, spinal cord injuries, pressure leg ulcers, strokes, subarachnoid hemorrhage, lymphedema, orthostatic hypotension, dependent edema, lower extremity fractures, reconstructive orthopedic surgery, lumbar spine surgery, face and chest injuries, major head injuries, venous hypertension management and torn muscle leg injuries. Additionally, the invention may be used for burn scar management.

Whereas previous and current compression bladders are/were cumbersome, potentially dangerous if used on the patient improperly, not user friendly, required to be installed with patient assistance, are not suitable for home or non-hospital use in a therapeutic. setting and expensive, the present invention is portable, less costly to manufacture, can be installed on the patient without requiring patient transport, is very user friendly, and can be installed and used by the patient without assistance.

### BRIEF DESCRIPTION OF THE DRAWINGS

FIG. 1 depicts a top view of the invention.

FIG. 2 depicts a side view of the compression device installed with operational details of the inlet valve, flapper check valve and hand pump.

FIG. 3 depicts a cutaway view of the the inlet T-Valve without secondary shut-off valves

FIG. 4 depicts a section of a lower or upper bladder showing, the plastic molded liquid inlet assembly bonded to the depicted bladder.

### DETAILED DESCRIPTION ION OF THE INVENTION

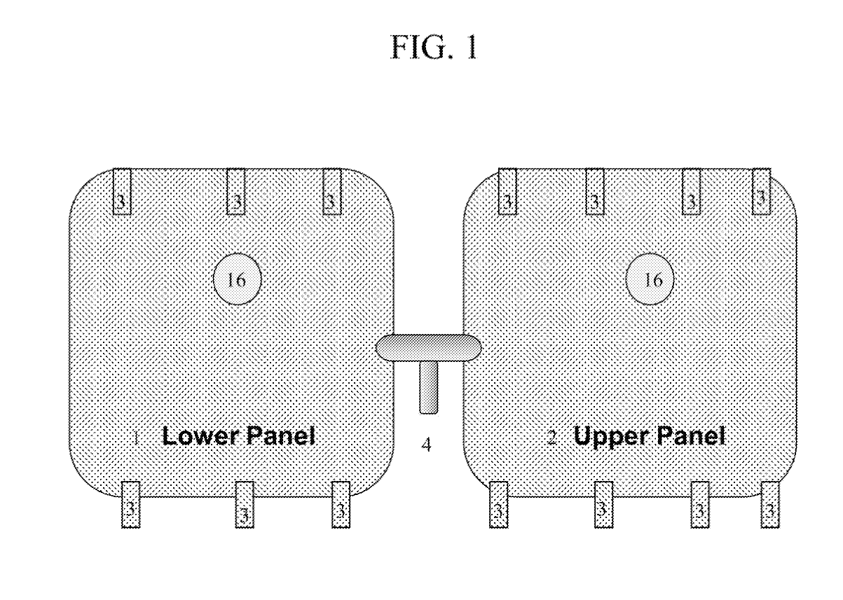

Referring to FIG. 1, an anti-blood pooling device for the treatment of blood flow issues is depicted. The device is used to compress a limb of a human. In an exemplary embodiment, the invention is comprised of a lower bladder 1, an upper bladder 2 and a plurality of hook and loop fasteners 3 suitably placed to allow compressive closure of each of the bladders 1 and 2 over the limb of a patient. Bladders 1 and 2 may be made of any suitable material. In the exemplary embodiment, one bladder 1 or 2 is suitable for use on one end of a joint of a limb, such as a knee or elbow, with the other bladder 1 or 2 is placed on the other side of the joint. For example, in a typical use, bladder 1 may be placed on a leg calf and bladder 2 may be placed on the thigh.

Bladder 1 and bladder 2 are fixedly or removeable and also flexibly connected by a t-valve 4 allowing simultaneous inflation of bladders 1 and 2. As further shown in FIG. 1, during use, bladder 1 may be secured around the lower limb of a patient. Bladder 1 is sized to fit effectively over a limb-sized object. Hook and loop fasteners close bladder 1 over the limb. Simultaneously, bladder 2 is placed on the upper limb of the patient. The t-valve 4 may be made sufficiently long to allow each of bladders 1 and 2 to be placed effectively as high or low on the limb as needed.

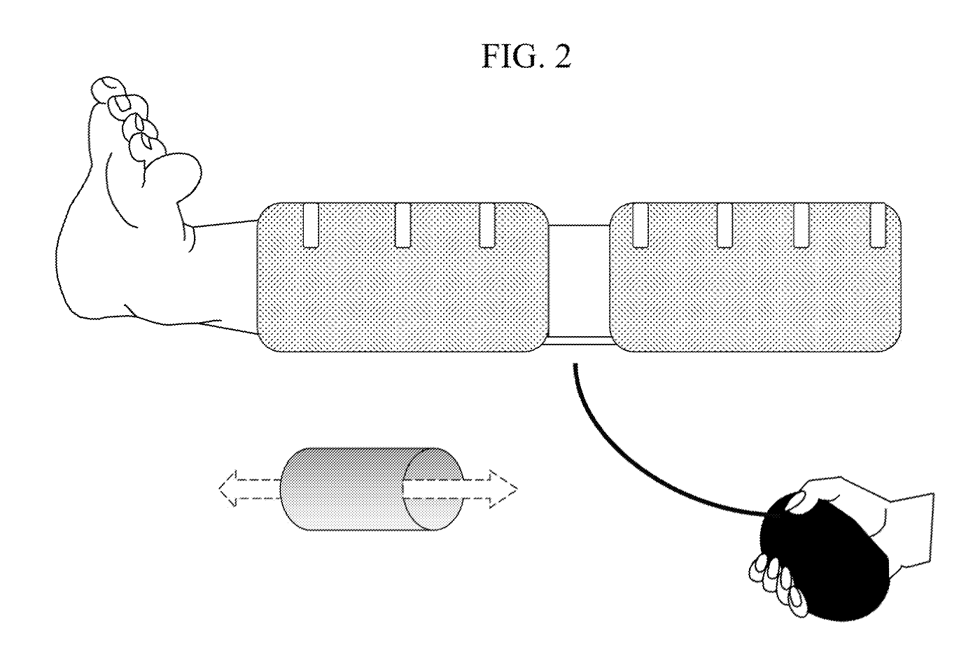

Referring now to FIG. 2, the invention is inflated with a suitable liquid, such as air or exhaled breath. In the exemplary example, to the inlet port of the t-valve 4 is attached a pressure gauge 8, an air tube 5 and a hand pump 7. The plurality of hook and loop fasteners 3 allow simple installation on a limb, either by a health care worker or the patient. Although hook and loop fasteners are described, any suitable fasteners may be used. The installer then pumps the bladders 1 and 2 by the available inflation means, in this exemplary embodiment a hand pump 7 Any form of other inflation means may be used, including blowing into the t-valve or use of a motorized pump.

In an alternate embodiment, a liquid may be placed in bladders 1 and 2. Bladders 1 and 2 are filled either through t-valve 4 by suitable means of by port 16 in each of bladder 1 and 2. A suitable liquid includes water, which may be warmed or cooled to a desired temperature. For purposes of this disclosure, bladders 1 or 2 may be filled with any suitable fluid, including any suitable vas or liquid.

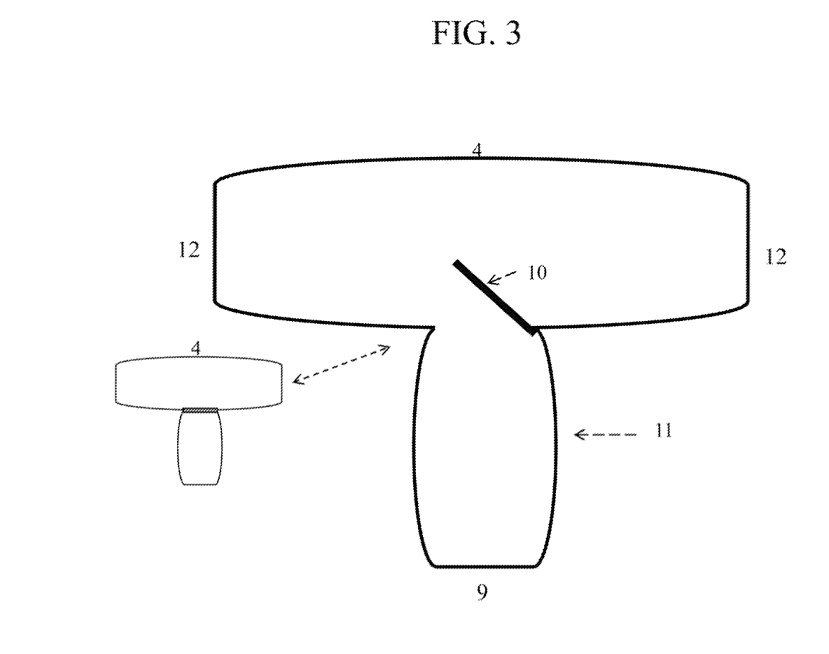

Referring now to FIG. 3, the t-valve 4 comprises an air inlet port 11 further comprising a nipple 9 suitable to receive the air tube 5. Fluids exit the t-valve 4 via two air outlets 12, one each to a bladder 1 or 2. Hingedly affixed within the t-valve 4 is a flexible valve flapper 10. As fluid flows into the t-valve, the flapper 10 opens to allow fluid to inflow. When in-flow pressure is reduced, such as between breaths when inflated by lung power, the fluid pressure in the bladders 1 and 2 pushes the flapper 10 into a closed position.

In an alternate embodiment, the t-valve include one or two shut off valves leading to bladders 1 or 2. In this embodiment, the user may shut of fluid flow to one or the other bladder 1 or 2, as indicated by patient need.

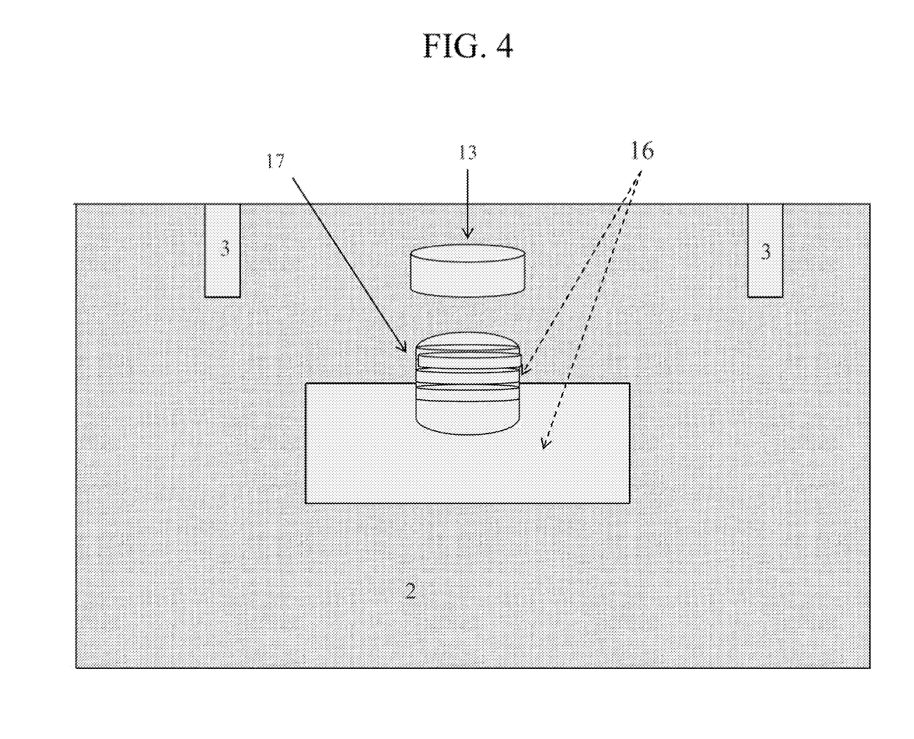

Referring now to FIG. 4, details of the alternate liquid fill port 16 are shown. Port 16 may be fixedly and air-tightedly attached to each of bladder 1 and 2. In a typical embodiment, port 16 is formed with screw threads 17 and capped with a mated cap 13.

Both upper and lower bladder sections of the device are flexible and easily rolled or remain flat for easy storage. Depending on usage rates, each of bladder 1 and 2 are sized the same or modified to fit the different sizes between the upper and lower part of the limb

In use, bladders 1 and 2 when inflated exert pressure on the veins of the patient's leg(s), when wrapped about the patient's legs and secured with hook and loop fasteners 3, impose the desired pressure, which may be varied based on need. Pressure at a certain level may be imposed to assist venous support for diabetes care. Pressure at another level may be imposed to control bleeding for an open leg wound. It is generally known in health care that the pressure imposed by a compression device should not exceed the diastolic blood pressure of the patient. The use of the controlled input pumps and pressure gauges allow suitable control to prevent over-pressurization.

The exterior of the device is made of a scratch retardant or tear resistant material, such as Gortex®. The bladders 1 and 2 are made of a rubberized, expandable material when inflated by a fluid. Both materials are sewn together at the seams and bonded to form a tight seal.

An optional pressure relief burst valve (not depicted) may be installed to regulate the fluidic pressure so as to not overinflate the bladders and to prevent an dangerous tourniquet type blood flow stoppage.

### ADVANTAGES OF IRIS INVENTION OVER EXISTING EQUIPMENT NOW USED

This invention is very storable, portable, and quick to install in battlefield operations.

Simpler and far less costly than existing products and pneumatic compression devices

Can be cleaned in regular laundry operations.

Ease of patient installation; can be easily self-installed; can be used under or over existing clothing if necessary.

Smaller and lighter in weight than other current products.

Easier to manufacture; Less costly to fabricate.

Designed for both consumer and professional applications. Has many civilian applications for ambulances, first aid, bed-ridden patients, pre and post surgeries, athletes and sports activities.

Longer life time and usage than current compression elastic stockings.

Ability to isolate and direct air or liquid flow to the upper or lower bladder.

Capability to adjust the proper compression around the legs/arms to suit individual patient needs and comfort.

Do not have to place in contact with skin to function properly.

Provides improved leg support [especially better than compression stockings].

Greater patient comfort and wear ability that prior art; can be worn under or over other clothing; prior art cannot.

Quicker to install and start operating than other products on the market.

This invention is designed to have less effects of pulmonary edema contraindication than the MAST due to less auto transfusion of blood to the central circulation.

Can also be used for arms and hands, whereas prior art of MAST and PASG cannot, and are trousers only. NOTE: can also use chilled or warm water in lieu of air to treat inflammation.

Prevention/treatment of orthostatic intolerance in susceptible individuals.

Wider applications for the device in more diversified markets.

What is claimed:

1. A compression device of low-cost, lightweight, easy-to-apply construction comprising two separate, double walled, sealed and fluid-tight bladders connected by a t-shaped connection means and further comprising means within the t-shaped connection means to prevent backflow of fluid and the simultaneous inflation of the two bladders with fluid.

2. The compression device of claim 1 in which fluid inflation may be made by one of squeeze pump, oral exhalation, or motorized pump.

3. The compression device of claim 1 in which the fluid of inflation is one of gas or liquid, including, without limitation, air, breath or water.

4. The compression device of claim 3 in which the fluid of inflation may be hot, warm, tepid, cool or cold.

5. The compression device of claim 1 in which the quick installation is accomplished using a plurality of positioned hook and loop fasteners.

6. The compression device of claim 1 in which the construction of the device is lightweight, flexible and easily stored.

7. A compression device of claim 1 in which the t-shaped connection means further comprises a directional shut oft valve to prevent fluid flow into one or the other bladders as selected by the user or applier.

8. A compression device of claim 1 in which the device made be cleaned for external use by household laundry for reuse.
